(19) United States
(12) Patent Application Publication
(10) Pub. No.: US 2023/0175989 A1
(43) Pub. Date: Jun. 8, 2023

(54) COMPOUND REFRACTIVE X-RAY LENS AND PHOTON COUNTING DETECTOR DEVICE

(71) Applicant: Cobham Advanced Electronic Solutions Inc., Arlington, VA (US)

(72) Inventor: Michael Simon, Colorado Springs, CO (US)

(21) Appl. No.: 17/871,590

(22) Filed: Jul. 22, 2022

Related U.S. Application Data
(60) Provisional application No. 63/285,935, filed on Dec. 3, 2021.

(51) Int. Cl. G01N 23/20008; G01N 23/046

(52) U.S. Cl. CPC G01N 23/20008; G01N 23/046; G01N 2223/419

(57) ABSTRACT

Apparatuses and methods are provided for generating one or more images using an example apparatus. An example apparatus includes a plurality of pixel elements fabricated on two or more substrates, wherein each pixel element comprises a plurality of compound refractive lenses. Each compound refractive lens comprises a plurality of concave lenses and each compound refractive lens defines a proximal end and distal end. Each pixel element further comprises a plurality of photon counting detectors, wherein each photon counting detector is configured to receive a beam exiting from the distal end of a particular compound refractive lens.

### CROSS-REFERENCE TO RELATED APPLICATION

The present application claims the benefit of U.S. Provisional Patent Application Ser. No. 63/285,935 filed on Dec. 3, 2021, the entire contents of which are incorporated by reference herein.

### TECHNICAL FIELD

The disclosed embodiments relate generally to a diagnostic or therapeutic device and, more particularly, to a diagnostic or therapeutic device which comprises a compound X-ray lens and photon counting detector.

### BACKGROUND

Computerized tomography (CT) medical imaging scans use a series of X-rays to obtain detailed internal images of an individual non-invasively for diagnostic or therapeutic purposes. Typically, multiple, X-Ray measurements may be taken at different angles about an individual's body and the resulting X-Ray measurements are then reconstructed using various algorithms to produce a cross-sectional image of said body.

### BRIEF SUMMARY

Various embodiments of the present invention described herein relate to apparatuses, systems, methods, computing devices, computing entities, and/or the like for a diagnostic or therapeutic device which comprises a compound lens and a photon counting detector.

In an example embodiment, an apparatus comprises: a pixel element fabricated on a substrate, the pixel element comprising: a compound refractive lens, wherein i) the compound refractive lens comprises a plurality of concave lenses and ii) the compound refractive lens defines a proximal end and distal end; and a photon counting detector, wherein the photon counting detector is configured to receive a beam exiting from the distal end of the compound refractive lens.

In some instances, the compound refractive lens and the photon counting detector are separated by a focal gap distance. In some instances, the focal gap distance ranges between approximately 1 millimeters to 100 millimeters.

In some instances, the photon counting detector defines a detector length which extends from a detector proximal end to a detector distal end; and a plurality of electrodes are positioned on a top surface of the photon counting detector. In some instances, each of the plurality of electrodes are spaced approximately equidistant from one another. In some instances, each of the plurality of electrodes define approximately a same length. In some instances, the plurality of electrodes define one or more different lengths and the length of the electrodes increases from the detector proximal end to the detector distal end.

In some instances, the pixel element further comprising a plurality of integrated circuits, wherein each integrated circuit is electrically connected to one or more electrodes of the plurality of electrodes.

In some instances, the pixel element further comprises an edge processor configured to: receive one or more digital signals from the plurality of integrated circuits; and generate one or more images based at least in part one the one or more received digital signals.

In some instances, the photon counter detector length is approximately 3 centimeters.

In some instances, the compound refractive lens is configured to focus an incident beam.

In some instances, the compound refractive lens comprises less than 10,000 compound refractive lenses.

In some instances, the compound refractive lens defines a length of approximately 18.6 millimeters.

In some instances, each of the plurality of concave lenses define an inner-spatial width of approximately 23 micrometers.

In some instances, each of the plurality of concave lenses define an outer-spatial width of approximately 25 micrometers.

In some instances, each of the plurality of concave lenses define a length of approximately 35 micrometers.

In some instances, each of the plurality of concave lenses define a focal thickness of approximately 2.5 micrometers.

In some instances, the substrate is composed of silicon.

In some instances, the substrate is further composed of at least one of cadmium or tellurium.

In another example embodiment, an apparatus comprises: a plurality of pixel elements fabricated on two or more substrates, wherein each pixel element comprises: a plurality of compound refractive lenses, wherein i) each compound refractive lens comprises a plurality of concave lenses and ii) each compound refractive lens defines a proximal end and distal end; and a plurality of photon counting detectors, wherein each photon counting detector is configured to receive a beam exiting from the distal end of a particular compound refractive lens.

In some instances, a subset of the plurality of pixel elements defines a pixel plane and each pixel plane is fabricated on a single substrate.

In some instances, for each pixel element of a pixel plane: the photon counting detector defines a detector length which extends from a detector proximal end to a detector distal end; and a plurality of electrodes are positioned on a top surface of the photon counting detector.

In some instances, each pixel plane comprises a plurality of integrated circuits, wherein each integrated circuit is electrically connected to one or more electrodes of the plurality of electrodes of each pixel element included within the respective pixel plane.

In some instances, each pixel plane further comprises an edge processor configured to: receive one or more digital signals from the plurality of integrated circuits; and generate one or more images based at least in part one the one or more received digital signals.

In some instances, the two or more substrates are orthogonally joined with one another.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components or operations depicted in the figures may or may not be present in certain embodiments described herein. Some embodiments may include fewer (or more) components than those shown in the figures.

FIG. 1 depicts an example single pixel element of a pixel plane of a device in accordance with some embodiments described herein;

FIG. 2 depicts an example pixel plane of a device configured with a plurality of single pixels in accordance with some embodiments described herein;

FIG. 3 depicts an example device configured with a plurality of concatenated pixel planes in accordance with some embodiments described herein;

FIG. 4A depicts a schematic representation of a single pixel plane in accordance with some embodiments described herein;

FIG. 4B depicts a schematic representation of multiple pixel planes in accordance with some embodiments described herein;

FIG. 5 depicts a schematic representation of a top-down view of a single pixel element of a pixel plane in accordance with some embodiments described herein;

FIG. 6 depicts an example computing device configured to, in whole or in part, perform various operations described herein; and

FIG. 7 is a flowchart depicting a method for generating an image according to an example embodiment of the present disclosure.

In accordance with common practice, the various features depicted in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Some embodiments of the present disclosure will now be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

Numerous details are described herein in order to provide a thorough understanding of the example embodiments depicted in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as to avoid obscuring pertinent aspects of the embodiments described herein.

### Overview

As described above, CT medical imaging scans may use X-rays to non-invasively obtain detailed internal images of an individual and may be used for diagnostic or therapeutic purposes. Multiple X-ray measurements may be taken at different angles and used to produce cross-sectional images of an individual's body. Currently, CT device scanners have resolutions of 500 micrometers in the cross-sectional plane. The highest resolution CT device scanners have around 150 micrometer resolutions. However, devices with further improved resolution (e.g., sub 150 micrometer resolutions) are desirable as improved resolution allows for images with increased detailed to be generated and thereby allows for improved diagnostic or therapeutic ability.

In order to address these issues and others, embodiments of the present disclosure provide for a device which may generate one or more images in response to receiving one or more incident beams (e.g., X-ray beams). The device may include one or more pixel planes which are each fabricated on a substrate and include one or more pixel elements. A pixel element may include solely a compound refractive lens configured with a plurality of concave lenses to focus an incident beam or may include a compound refractive lens configured with a plurality of concave lenses to focus an incident beam and a photon counting detector configured to receive the beam. The photon counting detector may be a planar or detector. The photon counting detector may be fabricated with the compound refractive lens or separately from the compound refractive lens. The compound refractive lens may be separated from the photon counting detector by a focal gap distance. In some embodiments, the compound refractive lens may be located at the X-ray beam source. A plurality of electrodes may be positioned on a top surface of the photon counting detector and be configured to generate an electrical signal in response to the X-ray beam traversing through an associated bulk of the photon counting detector. One or more integrated circuits may further be electrically connected to one or more electrodes such that the integrated circuits are configured to generate a digital signal in response to received electrical signals from one or more electrodes. The one or more integrated circuits may provide the generated digital signals to an edge processor, which may be configured to generate one or more images based at least in part on the received digital signals. Furthermore, one or more pixel planes may be concatenated together via substrate bonding to yield a device capable of producing two-dimensional images with sub 150 micrometer resolution. The embodiments described herein allow for improvements that, as will be appreciated, may include minimizing pixel crosstalk, increased sensitivity, allowing for smaller pixel size, and/or using a lower dose of radiation (e.g., with X-ray beams).

### Example Device Configuration

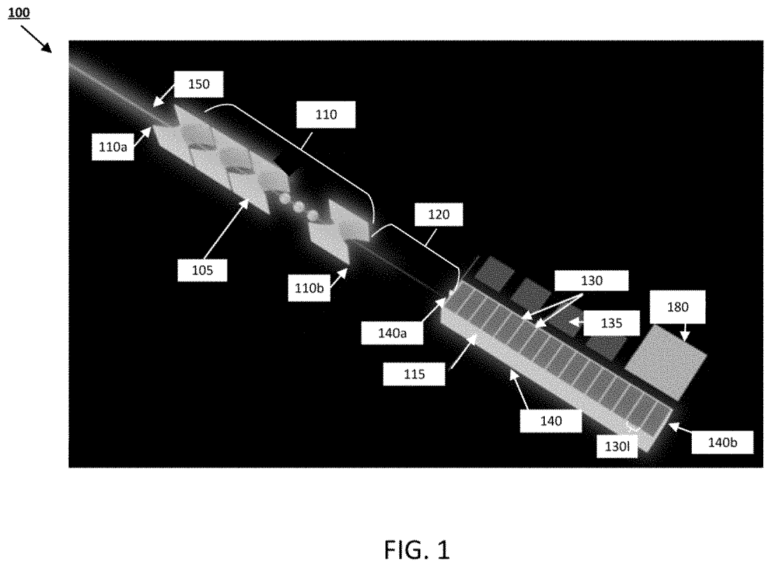

With reference now to FIG. 1, a single pixel element 100, with which the technology disclosed herein may be implemented, is depicted. The single pixel element 100 may include a compound refractive lens 110 and a photon counting detector (PCD) 140. The compound refractive lens 110 may include a plurality of concave lenses 105. The PCD 140 may be an edge PCD or an area scan PCD. The single pixel element 100 may be fabricated on a substrate using any suitable fabrication techniques. For example, in some embodiments, the plurality of concave lenses may be fabricated using nano-lithography techniques such as photo-lithography (e.g., optical lithography, quantum optical lithography), scanning lithography (e.g., electron-beam lithography, scanning probe lithography, proton beam writing, charged-particle lithography), soft lithography (e.g., polydimethylsiloxane (PDMS) lithography, microcontact printing, multilayer soft lithography), nanoimprint lithography, magnetolithography, nanofountain drawing, nanosphere drawing, neutral particle lithography, plasmonic lithography, stencil lithography, and/or the like.

The compound refractive lens 110 may define a proximal end 110a and distal end 110b, through which an incident beam (e.g., an X-Ray beam 150) may travel through. The compound refractive lens 110 may focus the incident beam to a desired beam diameter at focal point 115. The focal point 115 may occur within the PCD 140. The compound refractive lens 110 may include a plurality of concave lenses 105, which may serve to focus the incident beam. The concave lenses may be fabricated using the above described fabrication methods. The plurality of concave lenses 105 may be composed of the substrate material (e.g., silicon) on which the single pixel element 100 is fabricated on. The plurality of concave lenses 105 may be composed of a material different than the substrate (e.g. SU-8). In some embodiments, the medium between the plurality of concave lenses may be air. Alternatively, the medium between the plurality of concave lenses 105 may be vacuum. The number N of concave lenses 105 may, in part, determine the focal length of the beam. The compound refractive lens 110 may be configured to focus incident beams in the energy range of 20 kilo-electron volts (keV) to 150 keV.

The compound refractive lens 110 may be separated from the PCD 140 by a focal gap distance 120. In some embodiments, the focal gap distance 120 may range between approximately 1 millimeter to 100 millimeters. The focal gap distance 120 may also define where the focal point 115 of an incident beam occurs. In some embodiments, the medium within the focal gap distance 120 may be air. Alternatively, in some embodiments, the medium within the focal gap distance 120 may be vacuum.

The PCD 140 may be configured to receive an incident beam from the distal end 110b of the compound refractive lens 110. The PCD 140 may be oriented with the compound refractive lens 110 such that an incident beam may travel through the compound refractive lens 110, across the focal gap 120, and through the PCD 140. The PCD 140 may be a solid semiconducting material (e.g., silicon). The PCD 140 may define a detector length, which extends from a detector proximal end 140a to a detector distal end 140b. In some embodiments, the PCD length may be approximately 1 mm to 5 cm. In some embodiments, the PCD length may be approximately 3 centimeters.

In some embodiments, the substrate on which the single pixel element 100 is fabricated on is a silicon, a silicon nitride, and/or a SU-8 material. In some embodiments, the substrate may further include one or more of cadmium and/or tellurium. The inclusion of cadmium and/or tellurium may decrease the depth at which an incident beam energy is absorbed. In some embodiments, the substrate may be supplemented with cadmium and/or tellurium only at the PCD 140. This may be achieved using ion implantation such as via an ion gun. In some embodiments, cadmium or tellurium may compose approximately 5 percent of the substrate of at least the PCD 140 portion of the substrate. In other embodiments, cadmium or tellurium may compose approximately 50 percent of the substrate of at least the PCD 140 portion of the substrate.

A plurality of electrodes 130 may be positioned on and along a top surface of the PCD 140. The plurality of electrodes 130 may be spaced approximately equidistantly from one another. The plurality of electrodes 130 may each define a length 1301, which is parallel to the direction of travel of an incident beam (e.g., 150). In some embodiments, the length 1301 of each electrode is approximately the same. Alternatively, in some embodiments, the length 1301 of each electrode 130 is different. In some embodiments, the length 1301 of electrodes 130 may increase as the electrodes 130 are closer to the distal end 140b of the PCD 140, which may include the length 1301 increasing from the proximal end to the distal end. The plurality 130 of electrodes may generate a signal in response to movement of an incident beam (e.g., energy) within the bulk of the PCD 140. As the charged particles of the beam move through the bulk of the PCD 140, an electrical current is induced in one or more corresponding electrodes 130 positioned above the PCD 140 within which the beam has travelled until the beam is dissipated. The location of where the beam (e.g., 150) dissipates within the bulk of the PCD 140 is indicative of the beam energy and, thus, the one or more electrodes 130 which experienced an induced electrical current, and also define a position on the PCD 140, are indicative of the beam energy. A bias voltage may be present across one or more electrodes 130. In some embodiments, the bias voltage ranges between 400 V and 1,000 V.

To convert the electrical signal captured by the one or more electrodes 130, the pixel element 100 further includes a plurality of integrated circuits (ICs) 135. The ICs 135 may be readout integrated circuits (ROICs) configured to convert the signal captured by the one or more electrodes 130 into a digital signal. The plurality of ROICs may be positioned along the length of the PCD 140 and/or at the distal end 140b of the PCD 140. Each ROIC 135 may be electrically connected to one or more electrodes of the plurality of electrodes 130 such that the ROICs 135 may capture any induced signal in the electrodes 130 and generate one or more digital signals. Furthermore, the plurality of ROICs 135 may be electrically connected to an edge processor 180 and may provide the one or more digital signals to the edge processor 180.

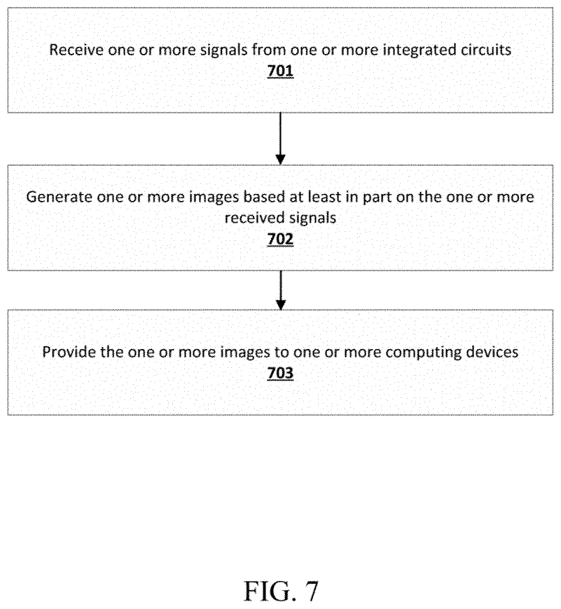

The pixel element 100 may further include an edge processor 180. The edge processor 180 may be configured to receive the one or more signals from the plurality of integrated circuits 135 and generate one or more images based at least in part one the one or more received signals. In some embodiments, the edge processor 180 may use on or more machine learning models and/or artificial intelligence models to generate one or more images based at least in part on the one or more received signals. A process of generating the one or more images is described in greater detail with respect to FIG. 7.

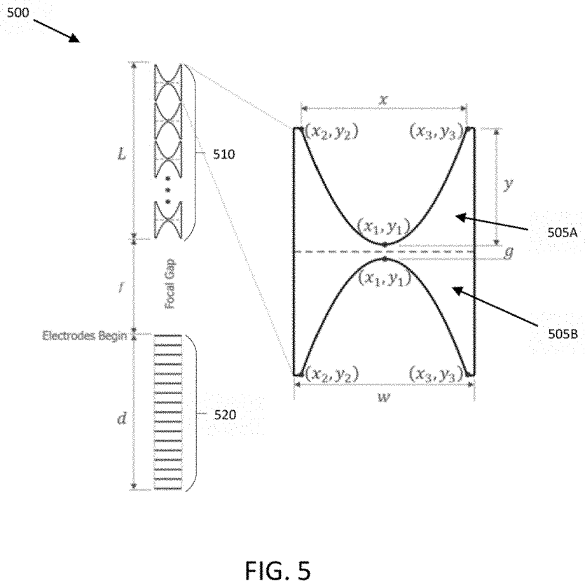

Referring now to FIG. 5, a top-down view of an embodiment of a pixel element 500 is depicted. As described above, the pixel element 500 includes a compound refractive lens 510 and a PCD 520, which are separated by a focal gap distance. As depicted in FIG. 5, the compound refractive lens 510 may define a total length L. In some embodiments, the total length L of the compound refractive lens 510 may be approximately 1 mm to 10 cm. In some embodiments, the compound refractive lens 510 may be approximately 18.6 millimeters. Additionally, as described above, the compound refractive lens 510 may include a plurality of concave lenses 505 (e.g., 505A, 505B). In some embodiments, the number of concave lenses may range between 400 to 600 concave lenses 505, although any number of concave lenses 505 may be contemplated. In some embodiments, 1 to 10,000 concave lenses 505 may be included within the compound refractive lens 510. In some embodiments, 500 concave lenses 505 may be included within the compound refractive lens 510.

FIG. 5 further depicts a detailed view of an example concave lens 505 (e.g., 505A is a first concave lens and 505B is a second concave lens). The concave lens 505 may have a substantially parabolic shape. In particular, a concave lens 505 may define an inner-spatial width x which spans from the opening of the concave lens 505 as defined by x₂ to the complementary opening of the concave lens as defined by x₃, thereby excluding any concave lens material thickness. In some embodiments, the inner-spatial width x is approximately 23 micrometers. The concave lens may also define an outer-spatial width w, which spans from the one end of material to the complementary end of the material, thereby including concave lens material thickness. In some embodiments, the outer-spatial width w is approximately 25 micrometers. Additionally, the concave lens may define a length y which spans from approximately the opening of the concave lens (e.g., x₂ or x₃) to the end of the lens at xᵢ. In some embodiments, the lengthy of the concave lens is approximately 35 micrometers. Each of the plurality of concave lenses may be separated by a focal thickness g. In some embodiments, the focal thickness g is approximately 2.5 micrometers.

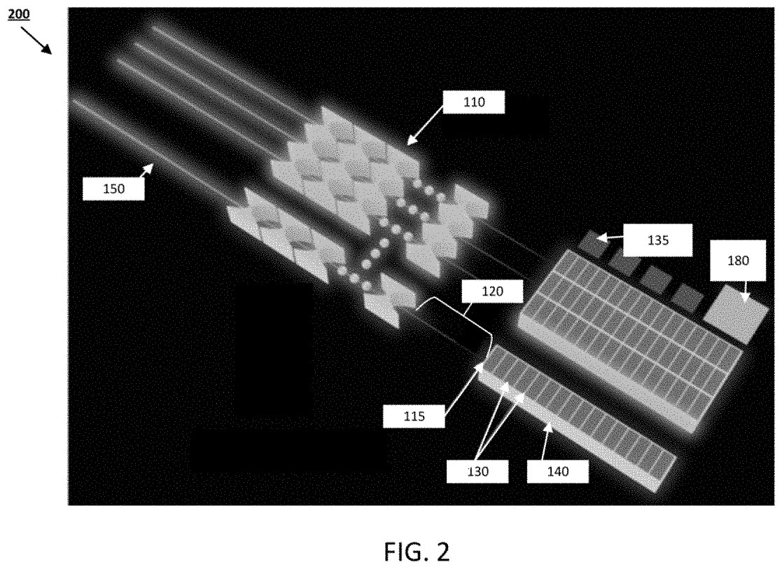

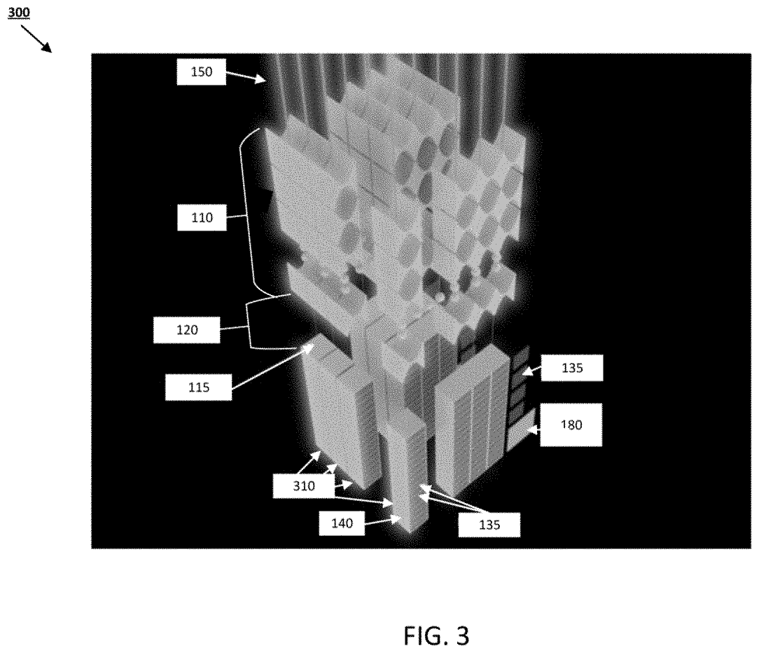

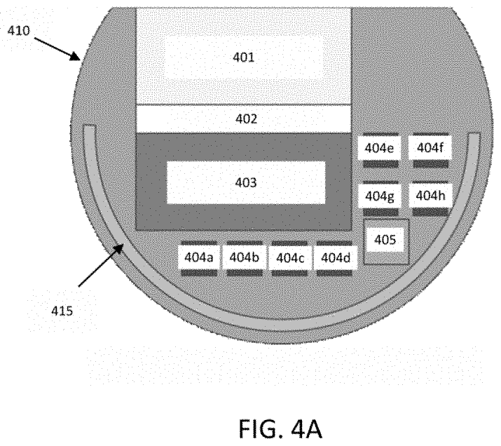

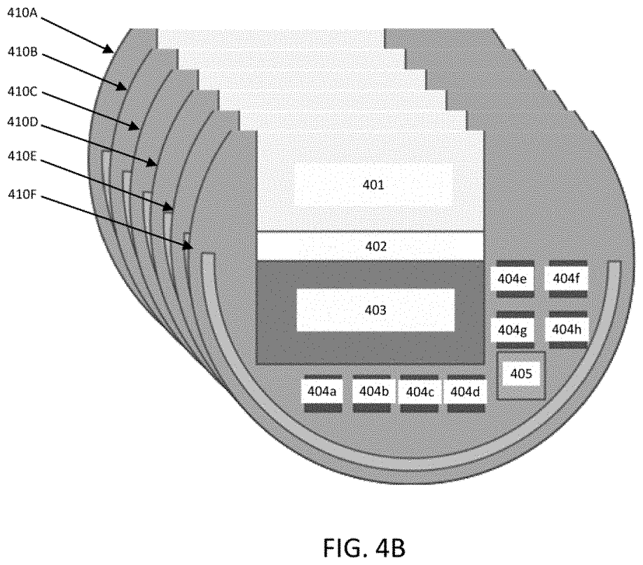

Referring now to FIG. 4, a schematic representation of a top down view of a pixel plane is shown. As depicted in FIG. 4, a substrate 410 includes a pixel plane, which further includes one or more single pixel elements 100, including compound refractive lens 401 and PCD 403 separated by a focal gap distance 402. Additionally, the substrate 410 includes ROICs 404a-h, which are positioned about the PCD 403. Furthermore, the substrate 410 includes an edge processor 405. In some embodiments, the substrate 410 may define a pixel plane, which may include one or more pixel elements 100, which are discussed herein with respect to FIGS. 2 and 3. The edge processor 405 may be flip-chip bonded to the substrate 410. The edge processor 405 may further be radiation hardened to protect the processor from exposure to stray radiation from an incident beam (e.g., 150). Each pixel plane (e.g., as defined by a substrate) may be concatenated orthogonally to one or more substrates (e.g., at a top and bottom surface of the substrate), such as by soldering or anodic bonding the substrates at a substrate bonding designation 415. As such, each pixel element 100, which may define a 1-dimensional signal, may be concatenated with other pixel elements 100 to define a 2-dimensional and/or 3-dimensional signal.

In some embodiments, the compound refractive lens 401 and PCD 403 may be removable. Thus the compound refractive lens 401 and the PCD 403 may be manufactured separately. This may also allow for a compound refractive lens 401 and/or a PCD 403 to be replaced without having to replace the other.

As described herein, a substrate 410 may define a pixel plane. A pixel plane may include one or more pixel elements 100 and may be fabricated on a single substrate 410. During fabrication, the compound refractive lens 401 and PCD 403 may be fabricated on a wafer. The ROICs 135 and edge processor 405 may be added to the wafer, and electrical connections between the components as described herein may be add. Multiple wafers defining multiple pixel planes may be stacked together. FIG. 4B depicts a schematic representation of an embodiment of multiple stacked pixel planes. In particular, six substrates 410A, 410B, 410C, 410D, 410E, and 410F are depicted in FIG. 4B. The stacked pixel planes may be, as described herein, bonded together at a substrate bonding designation 415 of each of the stacked pixel planes.

FIG. 2 depicts a pixel plane 200 which includes a plurality of pixel elements 100. Each pixel element 100 includes a compound refractive lens 110 and a corresponding PCD 140 separated by a focal gap distance 120. Furthermore, each pixel element 100 includes a plurality of electrodes 130 positioned on a top surface of the associated PCD 140. For a pixel plane with a plurality of pixel elements 100, a plurality of ROICs 135 may be positioned along a portion of a PCD 140 of the plurality of PCDs 140. Each ROIC 135 may be electrically connected to one or more electrodes 130 from one or more pixel elements 100. Furthermore, each pixel plane 200 may include an edge processor 180. As such, the inclusion of a plurality of pixel elements 100 within a pixel allows for the generation of two-dimensional images.

Furthermore, two or more pixel planes 200 may be concatenated with one another. As mentioned above, each pixel plane 200 is fabricated on a single substrate 410. FIG. 3 depicts a plurality of pixel planes 310 which each includes a plurality of pixel elements 100. The substrates which include the respective pixel planes 200 may be orthogonally joined together. For example, a second substrate which includes a second pixel plane 200 may be soldered onto a substrate which include a first pixel plane 200 and further, a third substrate which includes a third pixel plane 200 may be soldered onto the second substrate. As such, the pixel planes 200 may be concatenated together and thereby allow for the generation of three-dimensional images.

### Example Image Generation Configuration Method

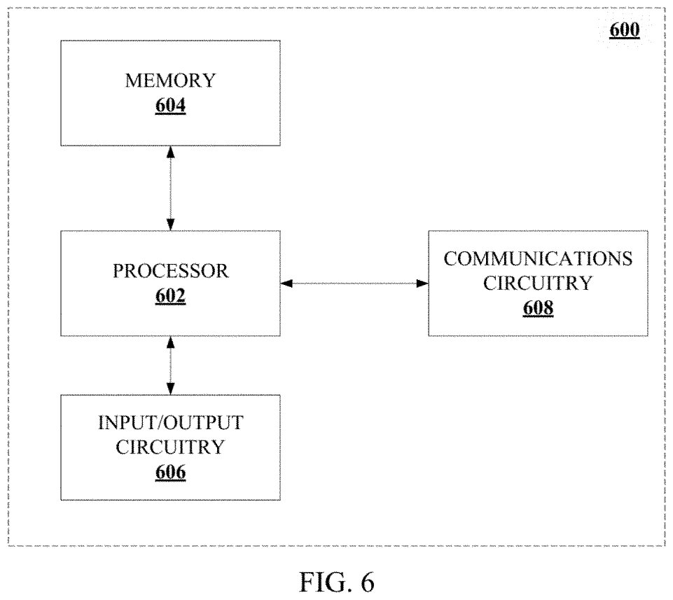

With reference to FIG. 7, a method of for generating one or more images according to embodiments of the invention is also provided (e.g., method 700). A computing device 600, such as depicted in FIG. 6 and described herein, may be configured to at least perform one or more operations and/or the like as described above. In some embodiments, the edge processor 180 may serve as the computing device 600. As shown at operation 701, the computing device 600 may include means, such as processor 602, communications circuitry 608, or the like, for receiving one or more signals from one or more integrated circuits 135 (e.g., ROICs). The one or more signals may define one or more values generated by the integrated circuits in response to one or more electrical signals from corresponding electrodes 130 of a device (e.g., such as devices defined in FIGS. 1-5).

At operation 702, the computing device 600 may include means, such as processor 602, memory 606, or the like, for generating one or more images based at least in part on the one or more received signals. In some embodiments, the computing device 600 may use one or more diagnostic or therapeutic machine learning models to generate the one or more images. The one or more diagnostic or therapeutic machine learning models may be trained machine learning models configured to receive signal input and generate an image representation based at least in part on the one or more signal inputs. In some embodiments, the trained machine learning models may be trained on simulated and/or real-world captured data that may be used as signal inputs. In some embodiments, the signal inputs may be comprised of input signals from the ROIC and/or data derived from these signal inputs. In some embodiments, the one or more diagnostic or therapeutic machine learning models may be trained to correlate the received signal input to a respective image region (e.g., which includes one or more pixels) and corresponding region color. A region color may be represented in gray-scale. The one or more images may have sub 150 micrometer resolution.

At operation 703, the computing device 600 may include means, such as processor 602, communication circuitry 608, or the like, for providing the one or more images to one or more computing devices. The one or more computing devices may be configured to display the one or more images to one or more end users, such as a medical team, who then may use the generated images to provide a medical diagnosis of the patient based on the images.

FIG. 7 depicts a flowchart describing the operations of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory of the computing device and executed by a processor of the computing device. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Example Computing Entity

In some embodiments, a device which includes one or more pixel elements 100 and/or pixel planes 200 may further comprise or otherwise be communicably coupled with a computing device 600. A computing device 600 may be configured to at least perform one or more operations, such as generating one or images, and/or the like as described herein.

In order to perform these operations, the computing device 600 may, as depicted in FIG. 6, include a processor 602, a memory 604, input/output circuitry 606, and/or communications circuitry 608. The computing device 600 may be configured to execute the operations of FIG. 7 described herein in connection with FIGS. 1-5 and 7. Although components 602-608 are described in some cases using functional language, it should be understood that the particular implementations necessarily include use of particular hardware. It should also be understood that certain of these components 602-608 may include similar or common hardware. For example, two sets of circuitry may both use the same processor 602, memory 604, communications circuitry 608, or the like to perform their associated functions, such that duplicate hardware is not required for each set of circuitry. The term “circuitry” as used herein includes particular hardware configured to perform the functions associated with respective circuitry described herein.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the computing device 600 may provide or supplement the functionality of particular circuitry.

In some embodiments, the processor 602 (and/or co-processor or any other processing circuitry assisting or otherwise associated with the processor) may be in communication with the memory 604 via a bus for passing information among components of the computing device 600. The memory 604 may be non-transitory and may include, for example, one or more volatile and/or non-volatile memories. In other words, for example, the memory may be an electronic storage device (e.g., a non-transitory computer readable storage medium). The memory 604 may be configured to store information, data, content, applications, instructions, or the like, for enabling the computing device 600 to carry out various functions in accordance with example embodiments of the present disclosure.

The processor 602 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the computing device, and/or remote or “cloud” processors.

In an example embodiment, the processor 602 may be configured to execute instructions stored in the memory 604 or otherwise accessible to the processor 602. Alternatively or additionally, the processor 602 may be configured to execute hard-coded functionality. As such, whether configured by hardware or by a combination of hardware with software, the processor 602 may represent an entity (e.g., physically embodied in circuitry) capable of performing operations according to an embodiment of the present disclosure while configured accordingly. Alternatively, as another example, when the processor 602 is embodied as an executor of software instructions, the instructions may specifically configure the processor 602 to perform the algorithms and/or operations described herein when the instructions are executed.

The computing device 600 further includes input/output circuitry 606 that may, in turn, be in communication with processor 602 to provide output to a user and to receive input from a user, user device, or another source. In this regard, the input/output circuitry 606 may comprise a display that may be manipulated by a mobile application. In some embodiments, the input/output circuitry 606 may also include additional functionality including a keyboard, a mouse, a joystick, a touch screen, touch areas, soft keys, a microphone, a speaker, or other input/output mechanisms. The processor 602 and/or user interface circuitry comprising the processor 602 may be configured to control one or more functions of a display through computer program instructions (e.g., software and/or firmware) stored on a memory accessible to the processor (e.g., memory 604, and/or the like).

The communications circuitry 608 may be any means such as a device or circuitry embodied in either hardware or a combination of hardware and software that is configured to receive and/or transmit data from/to a network and/or any other device, circuitry, or module in communication with the computing device 600. In this regard, the communications circuitry 608 may include, for example, a network interface for enabling communications with a wired or wireless communication network. For example, the communications circuitry 608 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the computing device 600 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described herein with reference to block diagrams and flowcharts. Thus, it should be understood that each block of the block diagrams and flowcharts may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowcharts. Accordingly, the block diagram and flowchart depictions support various combinations of embodiments for performing the specified instructions, operations, or steps.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of any appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of any appended claims. In this regard, for example, different combinations of elements and/or functions than those explicitly described above are also contemplated as can be set forth in some of any appended claims. Although specific terms are employed herein, they are used in a generic and descriptive sense only and not for purposes of limitation.

What is claimed is:

1. An apparatus comprising:
a pixel element fabricated on a substrate, the pixel element comprising:
a compound refractive lens, wherein i) the compound refractive lens comprises a plurality of concave lenses and ii) the compound refractive lens defines a proximal end and distal end; and
a photon counting detector, wherein the photon counting detector is configured to receive a beam exiting from the distal end of the compound refractive lens.

2. The apparatus of claim 1, wherein the compound refractive lens and the photon counting detector are separated by a focal gap distance.

3. The apparatus of claim 2, wherein the focal gap distance ranges between approximately 1 millimeters to 100 millimeters.

4. The apparatus of claim 1, wherein:
the photon counting detector defines a detector length which extends from a detector proximal end to a detector distal end; and
a plurality of electrodes are positioned on a top surface of the photon counting detector.

5. The apparatus of claim 4, wherein each of the plurality of electrodes are spaced approximately equidistant from one another.

6. The apparatus of claim 4, wherein each of the plurality of electrodes define approximately a same length.

7. The apparatus of claim 4, wherein the plurality of electrodes define one or more different lengths and the length of the electrodes increases from the detector proximal end to the detector distal end.

8. The apparatus of claim 4, the pixel element further comprising a plurality of integrated circuits, wherein each integrated circuit is electrically connected to one or more electrodes of the plurality of electrodes.

9. The apparatus of claim 8, wherein the pixel element further comprises an edge processor configured to:
receive one or more digital signals from the plurality of integrated circuits; and
generate one or more images based at least in part one the one or more received digital signals.

10. The apparatus of claim 4, wherein the photon counter detector length is approximately 3 centimeters.

11. The apparatus of claim 1, wherein the compound refractive lens is configured to focus an incident beam.

12. The apparatus of claim 1, wherein the compound refractive lens comprises less than 10,000 compound refractive lenses.

13. The apparatus of claim 1, wherein the compound refractive lens defines a length of approximately 18.6 millimeters.

14. The apparatus of claim 1, wherein each of the plurality of concave lenses define an inner-spatial width of approximately 23 micrometers.

15. The apparatus of claim 1, wherein each of the plurality of concave lenses define an outer-spatial width of approximately 25 micrometers.

16. The apparatus of claim 1, wherein each of the plurality of concave lenses define a length of approximately 35 micrometers.

17. The apparatus of claim 1, wherein each of the plurality of concave lenses define a focal thickness of approximately 2.5 micrometers.

18. The apparatus of claim 1, wherein the substrate is composed of silicon.

19. The apparatus of claim 18, wherein the substrate is further composed of at least one of cadmium or tellurium.

20. An apparatus comprising:
a plurality of pixel elements fabricated on two or more substrates, wherein each pixel element comprises:
a plurality of compound refractive lenses, wherein i) each compound refractive lens comprises a plurality of concave lenses and ii) each compound refractive lens defines a proximal end and distal end; and
a plurality of photon counting detectors, wherein each photon counting detector is configured to receive a beam exiting from the distal end of a particular compound refractive lens.

21. The apparatus of claim 20, wherein a subset of the plurality of pixel elements defines a pixel plane and each pixel plane is fabricated on a single substrate.

22. The apparatus of claim 21, wherein, for each pixel element of a pixel plane:
the photon counting detector defines a detector length which extends from a detector proximal end to a detector distal end; and
a plurality of electrodes are positioned on a top surface of the photon counting detector.

23. The apparatus of claim 22, wherein each pixel plane comprises a plurality of integrated circuits, wherein each integrated circuit is electrically connected to one or more electrodes of the plurality of electrodes of each pixel element included within the respective pixel plane.

24. The apparatus of claim 23, wherein each pixel plane further comprises an edge processor configured to:
receive one or more digital signals from the plurality of integrated circuits; and
generate one or more images based at least in part one the one or more received digital signals.

25. The apparatus of claim 20, wherein the two or more substrates are orthogonally joined with one another.
